(19) United States
(12) Patent Application Publication
(10) Pub. No.: US 2006/0209901 A1
(43) Pub. Date: Sep. 21, 2006

(54) Clock synchronization in a multistage switch structure

(75) Inventor: Jeong-in Kim, Gyeonggi-Do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG-Nortel Co., Ltd.

(21) Appl. No.: 11/304,390

(22) Filed: Dec. 14, 2005

(30) Foreign Application Priority Data
Dec. 15, 2004 (KR) 10-2004-0106303

(51) Int. Cl. H04J 3/06

(52) U.S. Cl. 370/503

(57) ABSTRACT

A clock synchronizing method in a multistage switch structure comprises providing a first reference clock signal to a first switch via a first clock recovery unit; providing a second reference clock signal to a second switch via a Phase Lock Loop (PLL); and providing a third reference clock signal to a third switch via a second clock recovery unit to synchronize first, second and third switches.

### CROSS REFERENCE TO RELATED APPLICATION

Pursuant to 35 U.S.C. § 119(a), this application claims the benefit of earlier filing date and right of priority to Korean Application No. 10-2004-0106303, filed Dec. 15, 2004, the contents of which are hereby incorporated by reference herein in their entirety.

### FIELD OF THE INVENTION

The present invention relates to an Ethernet switch system, and particularly to a clock synchronizing method having a multistage Ethernet switch structure.

### BACKGROUND

FIG. 1 is a block diagram illustrating a multistage connection structure of switches which can generally be constructed in an Ethernet N-way (N/W) communication switch. Ethernet N/W automatically detects the speed and type of transmission and adjusts the switch accordingly.

A clock synchronization in Ethernet N/W can be achieved by a method in which a physical layer unit (PHY) located at a front end of a switch receives data transferred through a media. Received data is processed by restoring a reference clock from the data. Another PHY located at a rear end of the switch uses the restored reference clock to transmit the data.

In the Ethernet switch system having a multistage connection structure as shown in FIG. 1, each Ethernet switch uses an independent reference clock signal for synchronization purposes. Therefore, a clock frequency difference may occur between switches.

FIG. 2 illustrates a structure of an Ethernet switch shown in FIG. 1. As illustrated, PHY receives data transmitted from another Ethernet switch via media and restores a clock signal from the received data. The restored clock signal is used as a reference clock for the switch. Data (e.g., an Ethernet packet) received by the switch is then processed and stored in a buffer within the Ethernet switch.

When transmitting the stored Ethernet packet to another Ethernet switch, the PHY uses its reference clock signal for the transmission. When data (i.e., a packet) is received at the full-wire speed, if the clock frequency used for writing the packet in the buffer is even slightly higher than a clock frequency used to read from the buffer, the clock difference may result in an overflow in the buffer, which may in turn result in packet loss.

The above scenario may not affect an Ethernet system using a single Ethernet switch. Also, it is not problematic if the packet loss occurs between two single Ethernet switch systems within an acceptable range. However, if the packet loss occurs in a system in which two or more switches have a multistage connection structure, the system will not properly operate.

Systems and methods are needed to overcome the problem associated with the related art.

### SUMMARY

A preferred clock synchronizing method in a multistage switch structure is provided. The method comprises providing a first reference clock signal to a first switch via a first clock recovery unit; providing a second reference clock signal to a second switch via a Phase Lock Loop (PLL); and providing a third reference clock signal to a third switch via a second clock recovery unit to synchronize first, second and third switches.

In accordance with one embodiment, the first switch and the second switch comprise central office terminals (COTs) in an upper Ethernet switch system. The second switch is coupled to the first switch to form a multistage switch structure. The third switch comprises a remote terminal (RT) in a lower Ethernet switch system. The first reference clock signal is restored based on synchronization data transmitted to the first switch. The second reference clock signal is provided by the first reference clock via the PLL. The third reference clock signal is restored based on synchronization data transmitted to the third switch.

In another embodiment, a clock synchronizing method in a multistage switch structure in an Ethernet-based N/W system is provided in which a plurality of Ethernet switches are connected to one another. The method comprises providing a reference clock signal from an upper Ethernet switch to a lower Ethernet switch for synchronizing the upper and lower switches; modulating/demodulating data in the lower Ethernet switch using the reference clock signal; transferring the data to the upper Ethernet switch; and synchronizing clock signals between the Ethernet switches.

Preferably, the upper and lower Ethernet switches are connected via a backplane. The reference clock signal is restored based on data transmitted to the upper Ethernet switch. The lower Ethernet switch is synchronized based on the reference clock signal of the upper Ethernet switch provided via a Phase Lock Loop (PLL). The lower Ethernet switch may comprise a plurality of Ethernet switches.

In accordance with another embodiment, a clock synchronizing apparatus in a multistage switch structure in an Ethernet-based N/W switch system having a multistage structure is provided. The apparatus comprises a first system comprising a first Ethernet switch for receiving data and switching and transmitting the received data; and a first clock recovery unit for providing a reference clock signal to the first Ethernet switch.

Also included may be a second Ethernet switch for switching and transmitting the data transmitted from the first Ethernet switch, and a Phase Lock Loop (PLL) for providing the same clock signal as the reference clock signal to the second Ethernet switch. A second system comprising a second clock recovery unit for restoring a first clock signal from the data transmitted from the first system, and a third Ethernet switch for receiving a second clock symbol provided by the second clock recovery unit may be also included.

In a preferred embodiment, the first system comprises at least one of a central office terminal (COT) system and an optical line termination (OLT) system. The second system comprises at least one of a remote terminal (RT) system and an optical network unit (ONU) system. The first Ethernet switch is coupled to the second Ethernet switch via a communication medium in the first system. In the first system, the second Ethernet switch comprises a plurality of Ethernet switches coupled to the first Ethernet switch via the backplane.

In one embodiment, the first system further comprises one or more PLLs for providing clock signals to the second Ethernet switch. The first system and the second system are coupled via transmission media. The transmission media comprises a backplane, for example.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating a multistage connection structure of a plurality of switches in an Ethernet environment.

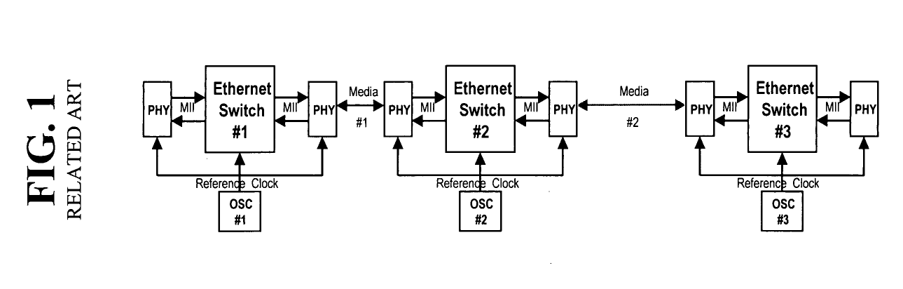

FIG. 2 is a detailed view of an Ethernet switch shown in FIG. 1.

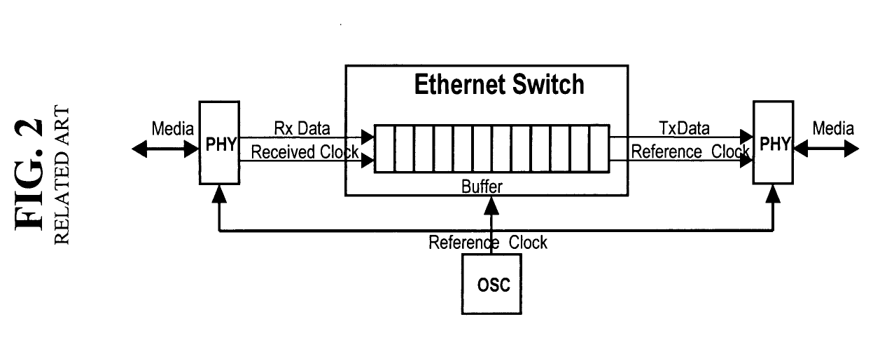

FIG. 3 is a block diagram of a clock synchronization in a multistage Ethernet switch connection structure in accordance with one embodiment.

FIG. 4 is a flowchart a method for implementing clock synchronization in an Ethernet system having a multistage switch structure in accordance with one embodiment.

Reference will now be made in detail to the preferred embodiments of the present invention, examples of which are illustrated in the accompanying drawings.

### DETAILED DESCRIPTION OF THE PREFERRED EMBODIMENT

In accordance with one aspect of the invention, an independent clock is used in a switch of an Ethernet switch system having a multistage structure. To avoid a data overflow—that may be caused by an offset of clock frequency—a clock synchronization system is provided in which a reference clock signal is provided to an upper Ethernet switch and a lower Ethernet by way of a Phase Lock Loop (PLL), as provided in further detail below.

It should be noted that in the following an exemplary embodiment of the invention is described as applicable to an Ethernet switch system. This application, however, is by way of example and the invention in alternative embodiments can be applied to switch systems operating according to other communication or networking specifications.

For example, one embodiment of the invention may be applicable to a method and apparatus for synchronizing clocks of a system environment in which several Ethernet switches are coupled to one another on a Wavelength Division Multiplexing-Passive Optical Network (WDM-PON) or an Ethernet-PON (E-PON) network, for example.

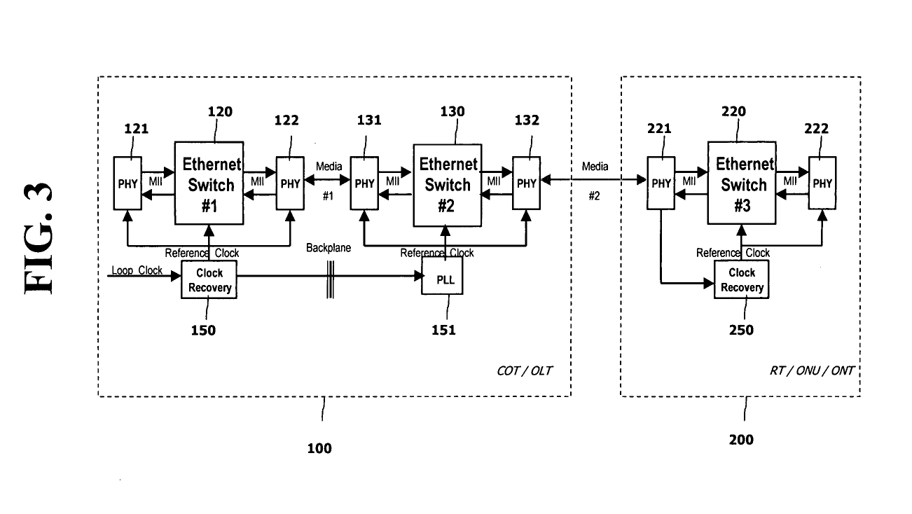

Referring to FIG. 3, an Ethernet switch system according to one embodiment of the invention comprises an upper system 100 having one or more multistage Ethernet switches and a lower system 200 connected to the upper system via transmission media. PHYs 121, 122, 131, 132, 221 and 222 are located at front and rear ends of each Ethernet switch system 100 and 200, respectively. PHYs convert and synchronize the data communicated to the switch system. Clock recovery units 150 and 250 and a Phase Lock Loop (PLL) 151 may be included in a preferred embodiment, for providing a clock to the upper and lower systems 100 and 200.

In some embodiments, the upper system 100 may comprise at least one of central office terminal (COT) system or an optical line termination (OLT) system, for example; and the lower system 200 may comprise at least one of a remote terminal (RT) system, an optical network unit (ONU) system, or an optical network termination (ONT) system, for example. The upper system 100 may also comprise a first Ethernet switch 120 as an upper switch; a second Ethernet switch 130 as a lower switch; and the PHYs 121, 122, 131 and 132.

Preferably, PHYs are located at the front and rear ends of the first Ethernet switch 120 and the second Ethernet switch 130. PHYs are configured for performing serial/parallel (S/P) or parallel/serial (P/S) converting and synchronizing of inputted or outputted data and transmitting/receiving the data. The clock recovery unit 150 is configured for providing a clock signal to the first Ethernet switch 120 and the PHYs 121 and 122.

The PLL 151 is configured for providing a clock to the second Ethernet switch 130 and the PHYs 131 and 132. The first Ethernet switch 120 in the upper system 100 is connected to the second Ethernet switch 130 via media (e.g., Media#1 in FIG. 3). The media may be a backplane, for example. The clock recovery unit 150 is connected to the PLL 151 via the backplane.

The lower system 200 comprises a third Ethernet switch 220; the PHYs 221 and 222 located at front and rear ends of the third Ethernet switch 220 for converting and synchronizing of inputted or outputted data and transmitting/receiving the data. The clock recovery unit 250 is for providing a clock to the third Ethernet switch 220 and the PHYs 221 and 222. The lower system 200 is connected to the upper system 100 via transmission media such as a subscriber line (e.g., Media#2 in FIG. 3).

In a preferred embodiment, the clock recovery unit 150 restores a reference clock signal from data transmitted to provide the restored reference clock signal to the first Ethernet switch 120 and the PHYs 121 and 122 for processing the data. The PHY 121 receives data modulated into an analog signal and demodulates the analog signal to a digital signal using the reference clock signal. Thereafter, the demodulated digital signal is transferred to the first Ethernet switch 120 via a media independence interface (MII).

The first Ethernet switch 120 switches the demodulated data and transfers the switched data to the PHY 122. The PHY 122 processes the transferred data and provides it to the PHY 131 via communication media such as the backplane. The PLL 151 provides the reference clock signal, provided to the first Ethernet switch 120, to the second Ethernet switch 130 and the PHYs 131 and 132, thereby synchronizing the clocks between the first Ethernet switch 120 and the second Ethernet switch 130.

When the data switched in the Ethernet switches of the upper system 100 is transferred to the lower system 200 via the subscriber line (e.g., the Media#2 in FIG. 3), the PHY 221 performs S/P converting for the transferred data and processes the converted data. The clock recovery 250 restores a clock from the processed data to provide the restored clock to the third Ethernet switch 220 and the PHY 222. As such, a clock synchronization between the Ethernet switches in the upper system 100 and between the Ethernet switches in the upper system and those in the lower system can be achieved.

In an exemplary embodiment, two Ethernet switches are dependently connected to each other as illustrated in FIG. 3. In other embodiments, however, two or more Ethernet switches may be dependently connected to one another. The Ethernet switches may apply the reference clock of the first Ethernet switch 120 to the PLL, thereby achieving clock synchronization.

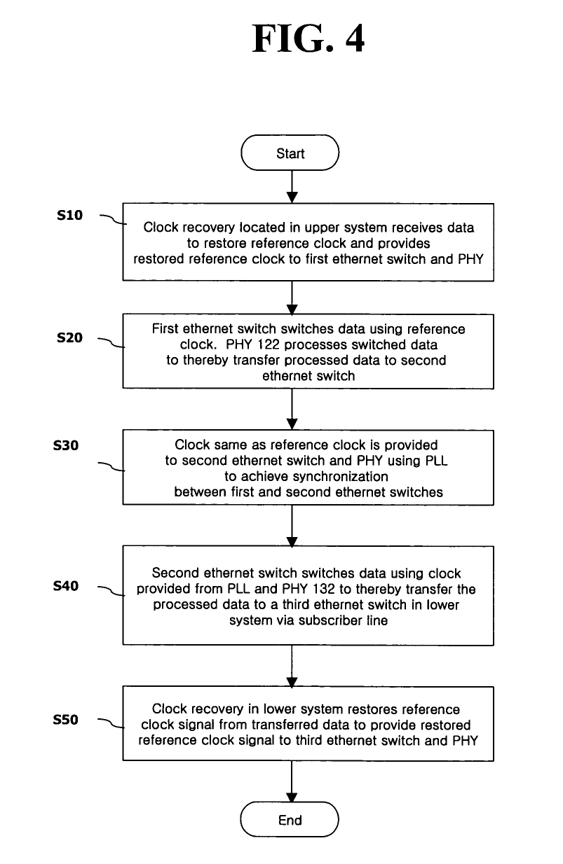

FIG. 4 is a flowchart illustrating a method for achieving clock synchronization in an Ethernet system having a multistage switch structure in accordance with one embodiment.

Referring to FIGS. 3 and 4, the clock recovery unit 150 located in the upper system 100 receives transmitted data to restore a reference clock signal, and provides the reference clock signal to the first Ethernet switch 120 and the PHYs 121 and 122 (S10). The data is thus switched by the first Ethernet switch 120 using the reference clock signal. The data is processed by the PHY 122 and transferred to the second Ethernet switch 130 via the backplane, for example (S20).

In a preferred embodiment, the PLL 151 provides the same clock signal as the reference clock to the second Ethernet switch 130 and the PHYs 131 and 132 to achieve clock synchronization between the first Ethernet switch 120 and the second Ethernet switch 130 (S30).

In one embodiment, the data switched by the second Ethernet switch 130 and then processed by the PHY 132 in the upper system 100 is transferred to the third Ethernet switch 220 in the lower system 200 via the subscriber line (e.g., the Media#2 in FIG. 3). The clock recovery signal 250 in the lower system 200 restores the reference clock signal from the transferred data to provide the restored reference clock to the third Ethernet switch 220 and the PHY 222 (S50).

Thus, Ethernet switches having the multistage structure in an Ethernet-based environment can be synchronized according to the provided method, and an overflow effect which may occur due to offset of clock frequencies can be prevented by way of a PLL providing the same reference clock to the multistage structure Ethernet switches.

In one embodiment, an Ethernet data packet is transmitted from a first Ethernet switch 120 located in the upper system 100 to a third Ethernet switch 220 located in the lower system 200 via a second Ethernet switch 130 at a maximum transmission rate. The same reference clock signal is provided to the first, second and third Ethernet switches 120, 130 and 220. Thus, a buffer overflow which may occur if the reference clock signal of the first Ethernet switch 120 is higher than the clock signal of the second Ethernet switch 130 can effectively be prevented.

As the present invention may be embodied in several forms without departing from the spirit or essential characteristics thereof, it should also be understood that the above-described embodiments are not limited by any of the details of the foregoing description, but rather should be construed broadly within its spirit and scope as defined in the appended claims.

What is claimed is:

1. A clock synchronizing method in a multistage switch structure comprising:
providing a first reference clock signal to a first switch via a first clock recovery unit;
providing a second reference clock signal to a second switch via a Phase Lock Loop (PLL); and
providing a third reference clock signal to a third switch via a second clock recovery unit to synchronize first, second and third switches.

2. The method of claim 1, wherein the first switch and the second switch comprise central office terminals (COTs) in an upper Ethernet switch system.

3. The method of claim 1, wherein the second switch is coupled to the first switch to form a multistage switch structure.

4. The method of claim 1, wherein the third switch comprises a remote terminal (RT) in a lower Ethernet switch system.

5. The method of claim 1, wherein the first reference clock signal is restored based on synchronization data transmitted to the first switch.

6. The method of claim 1, wherein the second reference clock signal is provided by the first reference clock signal via the PLL.

7. The method of claim 1, wherein the third reference clock signal is restored based on synchronization data transmitted to the third switch.

8. A clock synchronizing method in a multistage switch structure in an Ethernet-based N/W system in which a plurality of Ethernet switches are connected to one another, the method comprising:
providing a reference clock signal from an upper Ethernet switch to a lower Ethernet switch for synchronizing the upper and lower switches;
P/S or S/P converting data in the lower Ethernet switch using the reference clock signal;
transferring the data to the upper Ethernet switch; and
synchronizing clock signals between the upper and lower Ethernet switches.

9. The method of claim 8, wherein the upper and lower Ethernet switches are connected via a backplane.

10. The method of claim 8, wherein the reference clock signal is restored based on data transmitted to the upper Ethernet switch.

11. The method of claim 8, wherein the lower Ethernet switch is synchronized based on the reference clock signal of the upper Ethernet switch provided via a Phase Lock Loop (PLL).

12. The method of claim 8, wherein the lower Ethernet switch comprises a plurality of Ethernet switches.

13. A clock synchronizing apparatus in a multistage switch structure in an Ethernet-based N/W switch system having a multistage structure, the apparatus comprising:
an first switch system comprising:
a first Ethernet switch for receiving data and switching and transmitting the received data;
a first clock recovery unit for providing a reference clock signal to the first Ethernet switch;
a second Ethernet switch for switching and transmitting the data transmitted from the first Ethernet switch; and
a Phase Lock Loop (PLL) for providing the reference clock signal to the second Ethernet switch; and
a second switch system comprising:
a second clock recovery unit for restoring a first clock signal from the data transmitted from the first system; and
a third Ethernet switch for receiving a second clock signal provided by the second clock recovery unit.

14. The apparatus of claim 13, wherein the first system comprises at least one of a central office terminal (COT) system and an optical line termination (OLT) system.

15. The apparatus of claim 13, wherein the second system comprises at least one of a remote terminal (RT) system and an optical network unit (ONU) system.

16. The apparatus of claim 13, wherein the first Ethernet switch is coupled to the second Ethernet switch via a communication medium of the first switch system.

17. The apparatus of claim 13, wherein in the first switch system, the second Ethernet switch comprises a plurality of Ethernet switches coupled to the first Ethernet switch via a backplane.

18. The apparatus of claim 17, wherein the first switch system further comprises one or more PLLs for providing clock signals to the second Ethernet switch.

19. The apparatus of claim 13, wherein the first switch system and the second switch system are coupled via transmission media.

20. The apparatus of claim 19, wherein the transmission media comprises a backplane.
